(19) United States
(12) Patent Application Publication
(10) Pub. No.: US 2004/0193556 A1
(43) Pub. Date: Sep. 30, 2004

(54) Communication service system, communication service providing method, subscriber line concentrator and communication managing apparatus

(76) Inventors: Tomofuyu Miyamoto, Kawasaki (JP); Yutaka Suzuki, Kawasaki (JP); Motoharu Usumi, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/789,939

(22) Filed: Feb. 26, 2004

(30) Foreign Application Priority Data
Mar. 27, 2003 (JP) 2003-088688

(51) Int. Cl. G06F 17/60

(52) U.S. Cl. 705/412

(57) ABSTRACT

In a subscriber apparatus and a subscriber line concentrator used for an Internet connection service or the like, the subscriber line concentrator comprises a communication control unit multiplexing/demultiplexing packets from a subscriber I/F and a network connection I/F, the network I/F converting the formats of packets from the communication control unit and the network, a transmitting/receiving unit being able to transmit recorded usage period information data to a communication managing apparatus, and a recording unit recording the usage period information data relating to a connection history between the subscriber apparatus lent from a communication carrier and the network, which prevents communication for grasping the state of usage of the subscriber apparatus from suppressing the communication bandwidth used to provide the network service to the subscriber, and carry out an efficient packet processing in an access line in the network.

### BACKGROUND OF THE INVENTION

(1) Field of the Invention

The present invention relates to a communication service system, a communication service providing method, a subscriber line concentrator and a communication managing apparatus suitable for use for a providing service of an Internet connection service such as an FTTH (Fiber To The Home) service, an Ethernet service or the like, and an intranet connection service.

(2) Description of Related Art

In these years, construction of the infrastructure of the communication network is developed, thus a number of subscribers demand for communication environments in which a large capacity of data can be transmitted at a high speed. Each person can use a high-speed data transmission service such as FTTH, ADSL (Asymmetric Digital Subscriber Line) and the like.

FTTH is a communication service system in which an access line between an optical communication network and the premise of each subscriber is directly connected over optical fibers. FTTH can transmit both low-speed data such as voice data, FAX data, various file data and the like, and high-speed data such as static image data, dynamic image data and the like as a mixture. Whereby, the subscriber apparatus (subscriber) can be always connected to a network which can transmit high-speed data.

ADSL is a communication service system over telephone lines between a subscriber apparatus (subscriber apparatus terminal) and the Internet. In this communication service, the subscriber apparatus can always get an Internet connection service at a high speed and at a low rate from the communication carrier. In many cases, ADSL is used for an access line over which a subscriber apparatus is connected to an optical communication network transmitting high-speed digital data. The access line has a direction from a subscriber apparatus to a telephone office (hereinafter referred as an upstream) and a direction from the telephone office to the subscriber (hereinafter referred as a downstream).

Whereby, high-speed data transmission is available with metallic cables of an existing telephone line connecting a subscriber apparatus to a telephone office.

ISDN (Integrated Services Digital Network) service has been known for some time past. In ISDN, a service provider provides one D channel for control and two B channel for communication to a subscriber, whereby the subscriber can simultaneously use the two lines. Accordingly, the subscriber can make a telephone call and establish the Internet connection at the same time.

With widespread of the Internet, the number of communication carriers providing so-called broadband Internet connection services such as the FTTH service, the ADSL service and the like increases. Since the FTTH service is particularly estimated to be widespread in future, a number of communication carriers enter into the market.

With respect to the FTTH service, it is generally difficult for the communication carrier to estimate the number of subscriber apparatuses. When starting and providing the FTTH service, the communication carrier has to purchase subscriber apparatuses and subscriber line concentrators required to provide the Internet connection service from a manufacturer manufacturing communication equipments (communication apparatuses) or an agent of the communication equipments (hereinafter referred as an equipment vendor). Accordingly, the communication carrier has to purchase the subscriber apparatuses and the subscriber line concentrators in order to provide the service under circumstances where it is difficult for the communication carrier to estimate a required number of the subscriber apparatuses (for example, the number of the apparatuses to be sold), which leads to a constant risk in the business.

In the Internet connection services such as the FTTH service and the like, a technique used for LAN (Local Area Network) for enterprises or the like has been used. Therefore, functions unnecessary for the standards of LAN or the like are not provided in many cases. Incidentally, as an example of this technique, Ethernet is known.

Ethernet signifies standards defined by IEEE (Institute of Electrical and Electronics Engineers) 802.3 Committee unless specifically mentioned, and includes Ethernet (R).

For this, the subscriber apparatus and the subscriber line concentrator do not have a function of retaining information (hereinafter referred as connection history information) about a state of usage such as the time when use of the Internet connection service is initiated, the time when the use of the Internet connection service is terminated, and the like. For example, an operation manual relating to communication commands of the subscriber apparatus and the subscriber line concentrator does not mention that the subscriber line concentrator retains the connection history information (for example, refer to non-patent document 1).

The reason of the above is mainly that the time when the information about the subscriber apparatus is registered with the subscriber line concentrator does not always agree with the time when the subscriber apparatus is actually installed in the premise of a subscriber and the subscriber can use the Internet connection service.

Meanwhile, there is proposed a package rental business system of home appliances or the like to provide hardware resources such as home appliances or the like to the user in a way it copes with the form of use of each user or the residential environments of each user (refer to patent document 1, for example)

Non-patent Document 1: Fujitsu Limited, GeoStream A550/A380, product attached document (command operation manual)

Patent Document 1: Japanese Patent Laid-Open Publication No. 2002-269472

The connection history information about the state of use of the subscriber apparatus is important business information to both the communication carrier and the equipment vendor.

The equipment vendor obtains information about the state of use (the time when use of the service is initiated, the time when the user of the service is terminated and the like) of the subscriber apparatus. As a method of constantly monitoring the state of use, there are a first method in which the equipment vendor provides a dedicated line not used for the subscriber service between the communication system and a communication system communication managing apparatus, and a second method in which the state of use is monitored, using a part of the bandwidth of the line disposed between the communication managing apparatus and the Internet.

In the case of the first method, it is necessary to separately dispose a dedicated line not used for the service. In the case of the second method, there is a problem that the part of the bandwidth suppresses the communication bandwidth for common subscribers including the subscriber apparatuses, it is thus necessary to remove the suppression.

Meanwhile, there is examined a service form in which the equipment vendor lends a communication managing apparatus manufactured by the equipment vendor itself to the communication carrier, and collects a rental fee according to the state of use of the subscriber apparatus.

In this service form, the equipment vendor does not constantly monitor the state of use of the subscriber apparatus, but refers to the subscriber apparatus in the premise of the subscriber and the conditions of the installing work of the subscriber apparatus or the conditions of the actual work of the subscriber line concentrator in a network management center (office) provided by the management system, and obtains the state of use by manual operation by a system manager of the communication carrier, or through a different communication managing apparatus or a management system differing from and independent of the above communication managing apparatus.

In the rental service by the equipment vendor, the connection history information is referred by a system manager or a staff of the communication carrier of the communication managing apparatus, the management system or the like in many cases. Therefore, a service form in which the communication equipment vendor beforehand lends the subscriber apparatus and the subscriber line concentrator manufactured by the equipment vendor itself to the communication carrier, and collects the rental fee according to the state of use of the subscriber apparatus cannot be established.

Accordingly, a reduction in service fee by lending the apparatuses is not accellerated, which leads to suppression of the increase in number of the subscriber apparatuses. This suppression further leads to an obstacle to the spread of the FTTH service, and the access line between the subscriber apparatus and the high-speed network is a bottle neck to provide the high-speed network connection to the subscriber.

In the patent document 1, the subscriber apparatus, the subscriber line concentrator and the communication managing apparatus are not connected to the network.

### SUMMARY OF THE INVENTION

In the light of the above problems, an object of the present invention is to provide a communication service system, a communication service providing method, a subscriber line concentrator and a communication managing apparatus, whereby, in the communication between the subscriber apparatus and a subscriber line concentrator used for an Internet connection service, an intranet connection service or the like, it is possible to prevent communication used to grasp the state of usage of the subscriber apparatus from suppressing a communication bandwidth in which the subscriber uses the network service, and carry out an efficient packet processing in an access line of the network.

(1) Therefore, the present invention provides a communication service system providing a connection service between at least one subscriber apparatus and a network comprises a subscriber line concentrator provided between the subscriber apparatus among communication apparatuses used for the connection service and the network to record connecting history information data relating to a connection history between the subscriber apparatus and the network, and concentrating the subscriber apparatus, and a communication managing apparatus calculating a usage fee of the subscriber apparatus and the subscriber line concentrator lent out, on the basis of the connection history information data recorded in the subscriber line concentrator among the communication apparatuses used for the connection service. Accordingly, the equipment vendor can expect an increase in profit due to an expansion of the market and an increase in sales of the equipments because the barrier for the communication carrier to enter into the market.

(2) The present invention further provides a communication service providing method in a communication service system providing a connection service between at least one subscriber apparatus and a network, the communication service providing method comprising a lending step of lending a communication carrier providing the connection service a subscriber line concentrator possessed by an equipment vendor selling or lending communication apparatuses used in the communication service system to the communication carrier, and retaining a connection history between the subscriber apparatus lent from the communication carrier and the network and concentrating the subscriber apparatus, a recording step of recording, by the communication carrier, connection history information data relating to the connection history in the subscriber line concentrator lent out at the lending step, an obtaining step of obtaining, by the equipment vendor, the connection history information data recorded at the recording step, and a calculating step of calculating, by the equipment vendor, a usage fee of the subscriber apparatus and the subscriber line concentrator lent out, on the basis of the connection history information data obtained at the obtaining step. In a connection service such as an FTTH service or the like, the communication carrier can estimate the number of subscribers to purchase the communication managing apparatus. Accordingly, the communication carrier can decrease the initial equipment investment so that the barrier to enter into the service is lowered. The communication carrier can thus step into the business more easily, and expand the business in the future, that is, increase the equipments more easily.

(3) The present invention still further provides another communication service providing method comprising a selling step of selling a subscriber line concentrator managing a connection history between the subscriber apparatus and the network and concentrating the subscriber apparatus from an equipment vendor selling or lending communication apparatuses used in the communication service system to a communication carrier providing the connection service to a company lending the communication apparatus, a lending step of lending the subscriber line concentrator from the company to the communication carrier, a recording step of recording, by the communication carrier, connection history information data relating to the connection history in the subscriber line concentrator lent out at the lending step, an obtaining step of obtaining, by the company, the connection history information data recorded at the recording step, and a calculating step of calculating, by the company, a usage fee of the connection service on the subscriber apparatus and a usage fee of the subscriber apparatus and the subscriber line concentrator lent out, on the basis of the connection history information data obtained at the obtaining step. A rental company differing from the communication carrier, for example, can determine the usage fee according to an actual service usage period recorded in the communication managing apparatus, and collect the usage fee from the communication carrier.

(4) The present invention still further provides a subscriber line concentrator provided between at least one subscriber apparatus and a network among communication apparatuses used in a communication service system providing a connection service between the subscriber apparatus and the network to concentrate the subscriber apparatus, the subscriber line concentrator comprising a recording unit recording connection history information data relating to a connection history between the subscriber apparatus lent from a communication carrier providing the connection service and the network, and a transmitting unit transmitting the connection history information data recorded in the recording unit to a communication managing apparatus possessed by an equipment vendor selling or lending the communication apparatuses to the communication carrier and managing the connection history. The communication carrier can thus step into the business more easily, and cope with an expansion of the business in the future, that is, increase the equipments, more easily.

(5) The present invention still further provides a communication managing apparatus being able to obtain data from a subscriber line concentrator concentrating at lest one subscriber apparatus among communication apparatuses used in a communication service system providing a connection service between the subscriber apparatus and a network, the communication managing apparatus comprising an obtaining unit obtaining connection history information data relating to a connection history between the subscriber apparatus lent from a communication carrier providing the connection service and the network from the subscriber line concentrator, and a calculating unit calculating a usage fee of the subscriber apparatus and the subscriber line concentrator lent out, on the basis of the connection history information data obtained by the obtaining unit. It is thus possible to know the number of required subscriber apparatuses so that the equipment investment is accelerated.

(6) The recording unit of the subscriber line concentrator may further comprise a receiving unit receiving the connection history information data of each of the subscriber apparatuses from the communication managing apparatus. Alternatively, the recording unit may record the connection history information data obtained from the time that communication between the subscriber apparatus and the network becomes possible to the time that the communication between the subscriber apparatus and the network is cancelled. The equipment vendor can expect an increase in profit due to expansion of the market because the barrier for the communication carrier to enter into the service is lowered.

(7) In the latter communication service proving method, at the calculating step, the usage fee maybe fixedly determined on the basis of the number of the subscriber line concentrators and the number of the subscriber apparatuses. Alternatively, the usage fee may be selectively determined within a range from the number of the subscriber line concentrators to the number of the subscriber apparatuses concentrated by each of the subscriber line concentrators. It is thereby possible to readily read out the usage fee, not manually but automatically.

(8) The former communication service providing method may further comprising a first collecting step of collecting, by the communication carrier, the usage fee calculated at the calculating step from a subscriber, and a second collecting step of collecting, by the equipment vendor, the usage fee collected at the first collecting step from the communication carrier. Accordingly, the equipment vendor can collect the usage fee according to a period of time for which the communication carrier provides the service to the subscriber from the communication carrier, for example.

### BRIEF DESCRIPTION OF THE DRAWINGS

FIG. 1 is a schematic diagram of a communication service system according to a first embodiment of this invention;

FIG. 2 is a block diagram of a subscriber apparatus according to the first embodiment of this invention;

FIG. 3 is a diagram showing an example of a frame format for registering identification information according to the first embodiment of this invention;

FIG. 4 is a block diagram of a subscriber line concentrator according to the first embodiment of this invention;

FIG. 5 is a diagram showing an example of retained data in a subscriber usage period information retaining unit according to the first embodiment of this invention;

FIG. 6 is a block diagram of another communication managing apparatus according to the first embodiment of this invention;

FIG. 7 is a block diagram of another structure of the communication service system according to the first embodiment of this invention;

FIG. 8 is a diagram showing a sequence for illustrating a communication service providing method according to the first embodiment of this invention; and

FIG. 9 is a diagram showing a sequence for illustrating a communication service providing method according to a second embodiment of this invention.

### DESCRIPTION OF THE PREFERRED EMBODIMENTS

Hereinafter, description will be made of embodiments of the present invention with reference to the drawings.

### (A) Description of First Embodiment of the Invention

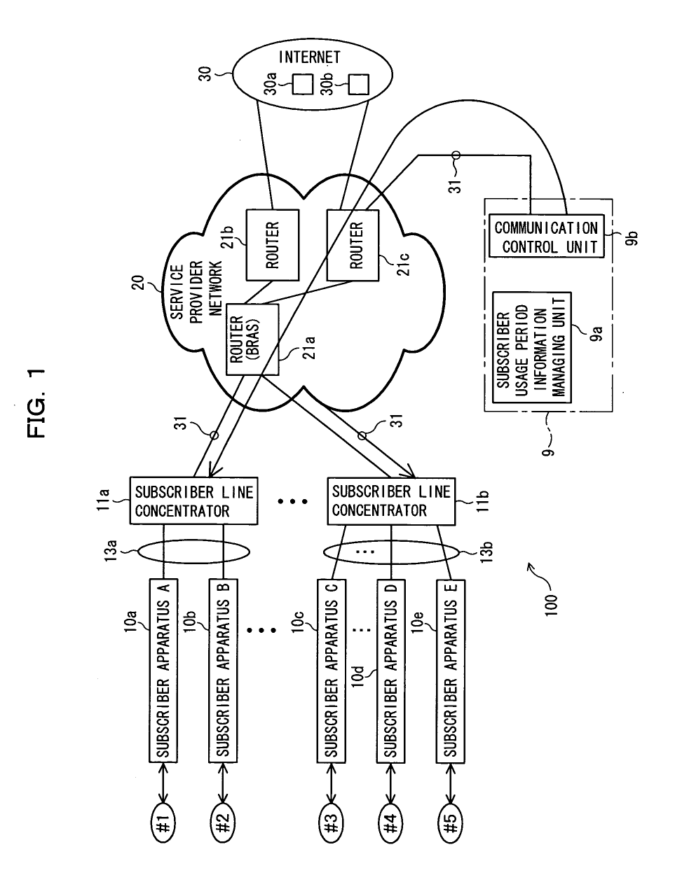

FIG. 1 is a diagram showing a schematic structure of a communication service system according to a first embodiment of this invention. A communication service system 100 shown in FIG. 1 provides an Internet connection service (a network connection service, a network connection line service: hereinafter referred as a connection service unless specifically mentioned) between a subscriber apparatus and the Internet, for example. The communication service system 100 comprises N (N representing a natural number) subscriber apparatuses 10a through 10e, N line groups (subscriber line groups: hereinafter referred as lines) 13a and 13b, M (M representing a natural number) subscriber line concentrators (concentrators) 11a and 11b, a transfer path 31, a network (service provider network) 20, the Internet 30 and a communication managing apparatus 9.

(1) Relationship Among Subscriber, Communication Carrier and Equipment Vendor

(1-1) Subscriber

A subscriber signifies a general user, who rends a subscriber apparatus 10a through 10e which can be connected to the network 20 by paying usage fee (a usage charge) to a communication carrier, and commences a connection service using the subscriber apparatus 10a through 10e.

(1-2) Communication Carrier

The communication carrier has the network 20 of its own to provide environments in which high-speed data communication is possible to subscribers. The communication carrier rends the subscriber apparatuses 10a through 10e from an equipment vendor, and lends the subscriber apparatuses 10a through 10e to contracting subscribers. As will be described later, the communication carrier records or retains information about a period of time for which each subscriber uses the connection service in the subscriber line concentrators 11a and 11b. The subscriber line concentrators 11a and 11b are provided between the subscriber apparatuses 10a through 10e and the network 20 among communication apparatuses used for the connection service, and record connection history information data (use period information data) relating to a connection history between each of the subscriber apparatuses 10a through 10e and the network 20.

(1-3) Equipment Vendor

The equipment vendor is a manufacturer manufacturing the subscriber apparatuses 10a through 10e used by the subscribers or an agency of the subscriber apparatuses 10a through 10e, for example. The equipment vendor lends the subscriber apparatuses 10a through 10e and the subscriber line concentrators 11a and 11b to the communication carrier. The equipment vendor can remotely read out the usage period information on each of the subscriber apparatuses 10a through 10e retained in the subscriber line concentrators 11a and 11b lent to the communication carrier by means of the communication managing apparatus 9.

In the communication service system 100, the subscriber line concentrators 11a and 11b of the communication carrier record service providing period information on each of the subscriber apparatuses 10a through 10e.

In the following description, terms of the subscriber, communication carrier and equipment vendor are used in like meanings. However, the subscriber, communication carrier and equipment vendor are not limited to the above examples, but may widely include enterprise, government, school and the like.

(1-4) Usage Period Information (Connection History Information)

Next, the usage period information will be described in more detail.

The usage period information is information on a period of time for which each of the subscriber apparatuses 10a through 10e uses the connection service, and also is information on a period of time for which the communication carrier provides the connection service, both of which will be hereinafter described as the usage period information. The usage period may be defined in various ways. In the following description, the usage period signifies a period from when the connection service is started (opening of the service line) to when the connection service is ended by canceling the contract (stop of the service line).

Each subscriber makes a contract to use the connection service with the communication carrier. Each of the subscriber apparatuses 10a through 10e transmits identification information to either one of the subscriber line concentrators 11a and 11b. The identification information is registered with either one of the subscriber line concentrators 11a and 11b. When the service becomes unnecessary, the subscriber apparatus 10a through 10e deletes the registration information in a relevant subscriber line concentrator 11a or 11b with which the identification information has been registered to end the service.

(1-5) Method for Obtaining Usage Period Information (Service Providing Period Information)

In the following description, there are two ways that the equipment vendor gets the service providing period information. As the first method, the service providing period information is notified from the subscriber line concentrators 11a and 11b to the communication managing apparatus 9, and the equipment vendor obtains the service providing period information notified from the communication managing apparatus 9.

As the second method, the equipment vendor uses the communication managing apparatus 9 to directly read the service providing period information on each of the subscriber apparatuses 10a through 10e retained in the subscriber line concentrators 11a and 11b, thereby obtaining the service providing period information.

(1-6) Method of Calculating Usage Fee

In a method of calculating the usage fee, the usage fee is determined on the basis of the service providing period information notified from the communication managing apparatus 9 and a contract between the equipment vendor and the communication carrier. Incidentally, it is possible to provide a fee billing function of notifying the communication carrier of the usage fee.

The equipment vendor may lend communication apparatuses such as the subscriber line concentrators 11a and 11b, the subscriber apparatuses 10a through 10b, etc. to the communication carrier, and provide services such as a system operation management service, an after-sale service and the like, following the lending of the communication apparatuses, on the basis of a contract between the equipment vendor and the communication carrier.

Next, the method of calculating the usage fee will be described in more detail.

When the number of the subscriber apparatuses 10a through 10e connected to one subscriber line concentrator 11a and 11b is increased, the bandwidth of the network 20 which can be used by each of the subscriber apparatus 10a through 10e is decreased, so that the usage fee to be charged on each of the subscriber apparatuses 10a through 10e by the communication carrier is decreased.

The usage fee to be collected from the communication carrier may be selectively determined within a range from the number of the lent subscriber line concentrators 11a and 11b “2” to a total “5” of the number of the subscriber apparatuses 10a and 10b “2” concentrated by the subscriber line concentrator 11a and the number of the subscriber apparatuses 10c through 10e “3” concentrated by the subscriber line concentrator 11b, in consideration of usable period information and the service fee to be collected from the subscribers by the communication carrier. In other words, the usage fee is set in consideration of a bandwidth that can be actually used and on the basis of a weight according to the number of each kind of the apparatuses (or regressively). The number of the subscriber apparatuses 10a through 10e connected to each of the subscriber line concentrators 11a and 11b can be determined from log information retained in the subscriber line concentrators 11a and 11b described above.

The above method of determining the usage fee is applicable in a second embodiment.

(2) Schematic Description of Communication Service System 100

(2-1) Subscriber Apparatuses 10a through 10e

Each of the subscriber apparatuses 10a through 10e is a communication apparatus or a communication terminal used by a subscribers #1 through #5 to get the connection service, and is a terminating equipment of FTTH, for example. The subscriber apparatuses 10a through 10e are installed in the premises of the subscribers #1 through #5, respectively.

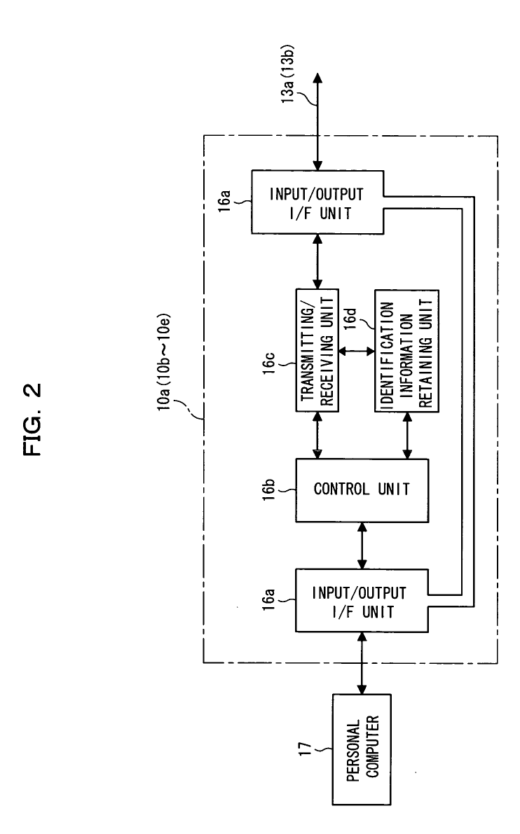

FIG. 2 is a block diagram of the subscriber apparatus 10a according to the first embodiment of this invention. The subscriber apparatus 10a shown in FIG. 2 comprises an identification information retaining unit 16d retaining identification information (subscriber apparatus identification information) A for identifying the subscriber apparatus 10a itself, a transmitting/receiving unit 16c transmitting/receiving packets to/from the subscriber line concentrator 11a over the line 13a, and transmitting the identification information A to the subscriber line concentrator 11a, a control unit 16b carrying out an input/output control on the transmitting/receiving unit 16c, the identification information retaining unit 16d and an input/output interface unit (input/output I/F unit) 16a to be described later, and an apparatus control on the subscriber apparatus 10a, and the input/output interface unit 16a having a plurality of physical ports and carrying out an input/output control on each of the physical ports. The input/output interface unit 16a interfaces between a personal computer 17 operated by the subscriber #1 and the subscriber apparatus 10a itself, and between the line 13a and the subscriber apparatus 10a itself.

Each of the subscriber apparatuses 10b through 10e retains corresponding identification information B, C, . . . or E, other parts of which are identical to those of the subscriber apparatus 10a. Here, the following description will be made, taking the subscriber apparatus 10a as an example. Incidentally, the lines 13a and 13b are similar to the lines described above.

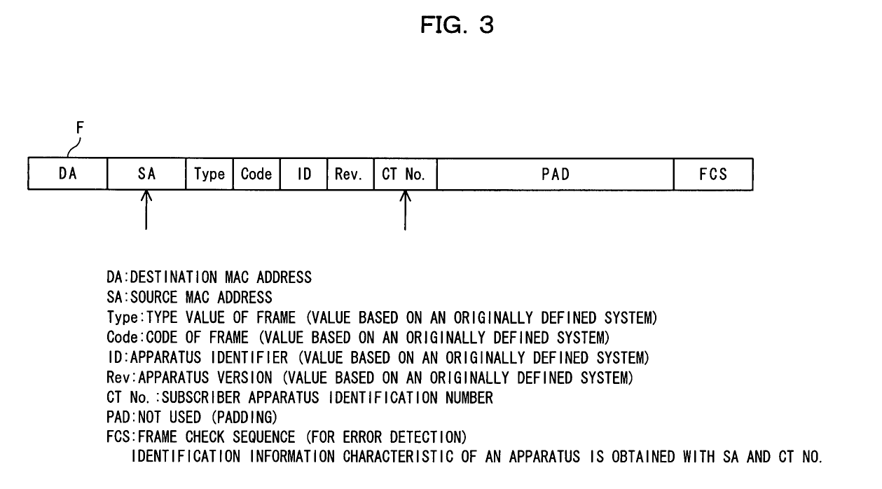

FIG. 3 is a diagram showing a frame format for registering the identification information according to the first embodiment of this invention. SA (Source MAC Address) and CT No. (Control Number: subscriber apparatus identification information) contained in a frame F shown in FIG. 3 cooperate with each other to function as identification information characteristic of each of the subscriber apparatuses 10a through 10e.

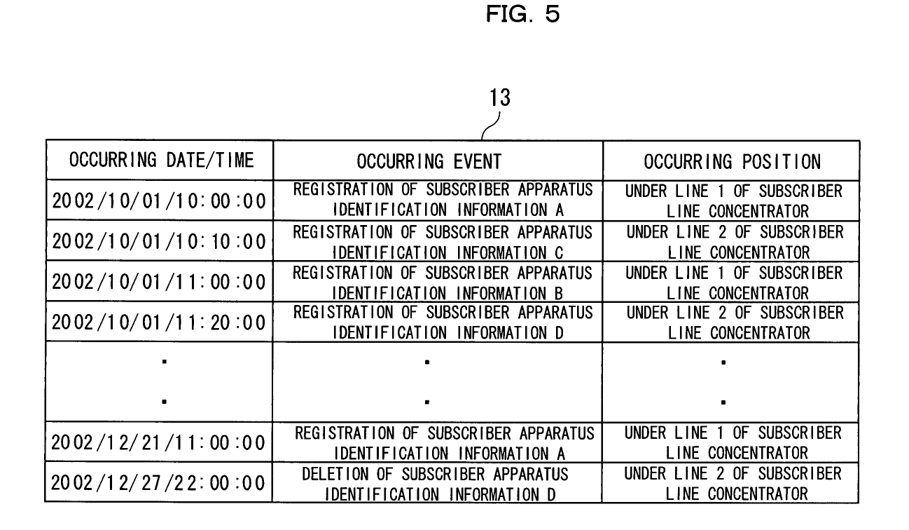

For instance, the identification information A is written, together with information about the date and time when an event occurs and the like, in a retaining unit (refer to FIG. 5, for example) of the subscriber line concentrator 11a, whereby the subscriber apparatus 10a is registered.

The frame F also contains DA (Destination MAC Address), Type (Type value of frame: a value based on an originally defined system), Code (a code of frame: a value based on an originally defined system), ID (Apparatus Identification: a value based on an originally defined system), Rev (Revise: the number of version of improvement of the apparatus or the like), PAD (Padding: not used), FCS (Frame Check Sequence: for error detection).

These are the same in a second embodiment to be described later.

Since the identification information A is generated according to the existing frame format, the communication service system 100 can be operated with the existing communication apparatuses and the existing communication process, or with a small modification.

When the subscriber uses the personal computer 17 to carry out the Internet connection operation, the subscriber apparatus 10a transmits information data and the like to the network 20. The subscriber apparatus 10a receives information data from the network 20 transmitted through the subscriber line concentrator 11a, and the received information is displayed on a display (not shown) of the personal computer 17.

With respect to the information data from the network 20 addressed to the subscriber apparatus 10a, the subscriber line concentrator 11a refers to the destination address information of the information data. When the subscriber line concentrator 11a retains information on a relationship between the address and the line, the subscriber line concentrator 11a transmits the information to the subscriber apparatus 10a accommodated by the subscriber line concentrator 11a.

When the subscriber line concentrator 11a does not retain the information on the relationship between the address and the line, the subscriber line concentrator 11a transmits the information data to all the subscriber apparatuses 10a through 10e.

Meanwhile, the subscriber apparatuses 10a through 10e and the subscriber line concentrators 11a and 11b correspond to slave machines and master machines, respectively.

(2-2) Lines (Line Groups) 13a and 13b

The lines 13a and 13b are transmission paths over which the subscribers access to the network 20. The subscriber line concentrator 11a and the subscriber apparatuses 10a and 10b accommodated by the line concentrator 11a are connected over the lines 13a, whereas the subscriber line concentrator 11b and the subscriber apparatuses 10c, 10d and 10e accommodated by the subscriber line concentrator 11b are connected over the lines 13b. Namely, the subscriber apparatuses 10a and 10b are managed (being followers of) by the subscriber line concentrator 11a, whereas the subscriber apparatuses 10c through 10e are managed by the subscriber line concentrator 11b.

(2-3) Subscriber Line Concentrators 11a and 11b

The subscriber line concentrator 11a is disposed between the subscriber apparatuses 10a and 10b, and the network 20 among communication apparatuses used for the communication system providing the connection service between the subscriber apparatuses 10a and 10b, and the network 20 to concentrate the subscriber apparatuses 10a and 10b. The subscriber line concentrator 11a retains the usage period information data between each of the subscriber apparatuses 10a and 10b, and the network 20.

The subscriber line concentrator 11b is almost identical to the subscriber line concentrator 11a, which concentrates the subscriber apparatuses 10c through 10e.

(2-4) Communication Managing Apparatus 9

The communication managing apparatus 9 can obtain data from the subscriber line concentrators 11a and 11b among the communication apparatuses used for the communication service system 100 providing the connection service between the subscriber apparatuses 10a through 10e and the network 20. The communication managing apparatus 9 has a recording means automatically recording the usage period information on each of the subscriber apparatuses 10a through 10e when each of the subscriber apparatuses 10a through 10e disposed in the premise of the subscriber is connected to the line. The recording means starts to write or update data of a subscriber usage period information retaining unit (recording unit) 13 to be described later, with a line connection as an opportunity, for example.

Whereby, the usage period information representing a start of use of the network 20 and an end of the use of the network 20 retained in the subscriber line concentrators 11a and 11b is remotely collected by the equipment vendor differing from the communication carrier providing the connection service.

Meanwhile, the subscriber apparatuses 10a through 10e and the subscriber line concentrators 11a and 11b correspond to slave machines and master machines, respectively.

(2-5) Network (Service Provider Network) 20

The network 20 provides a network service such as FTTH or the like, for example, wherein a BRAS (Broadband Remote Access Server) router 21a, and routers 21b and 21c (hereinafter referred as routers 21a through 21c when collectively referred) are connected to one another, for example.

The BRAS router 21a has a subscriber authenticating function, and can transfer and process high-speed packets or frames. Preferably, the network 20 is provided with the BRAS router 21a.

Practically, the BRAS router 21a authenticates the subscriber in cooperation with an authentication server managing a user ID and a password of each subscriber on the basis of a user ID and a password inputted by the subscriber when receiving an access from the subscriber. The BRAS router 21a processes data transmitted from the subscriber who has been successful in the authentication.

A packet from the subscriber is transferred to the Internet 30 via the subscriber apparatus, the subscriber line concentrator, the BRAS router 21a and the router 21b or 21c. A packet from the Internet 30 is transferred at a high speed to the subscriber line concentrator 11a or 11b via the router 21b or 21c and the BRAS router 21a.

The network 20 is operated by a service provider. The network 20 is a basic trunk of optical signals when the network 20 is FTTH, for example.

(2-6) Internet 30 and Transfer Path 31 The Internet 30 transmits and receives packets, and has a server or Internet terminals 30a and 30b corresponding to a part of LAN.

The transfer path 31 is a packet transfer path between the communication managing apparatus 9 and the line concentrators 11a and 11b. The transfer path 31 comprises a path inside the network 20, paths using lines between the network 20 and the subscriber line concentrators 11a and 11b, and a path using a line between the network 20 and the communication managing apparatus 9.

(2-7) Procedure for Registering Subscriber Apparatuses 10a through 10e

Each of the subscriber apparatuses 10a through 10e is connected to the line 13a or 13b, and transmits a frame containing the identification information A, B, . . . or E characteristic of the apparatus to the subscriber line concentrator 11a or 11b when the power is switched on.

When the subscriber line concentrator 11a receives a message from the subscriber apparatus 10a, a usage start time (or a usage start period, a usage start date or the like) is written in a memory (refer to FIG. 5 to be described later, for example) of the subscriber line concentrator 11a, whereby the subscriber apparatus 10a is registered and a registration confirmation message is transmitted to the subscriber apparatus 10a.

The subscriber apparatus 10a can thereby transmit and receive information data at a high speed to and from the internet terminal 30a via the subscriber line concentrator 11a over the network 20. The subscriber is provided the connection service such as FTTH or the like.

The procedure for registering the subscriber apparatus 10b is carried out like the subscriber apparatus 10a, repetitive description of which is thus omitted. Similarly, each of the subscriber apparatuses 10c through 10e is registered with the subscriber line concentrator 11b identical to the subscriber line concentrator 11a like the subscriber apparatus 10a, redundant description of which is thus omitted.

(3) Structure of Subscriber Line Concentrators 11a and 11b

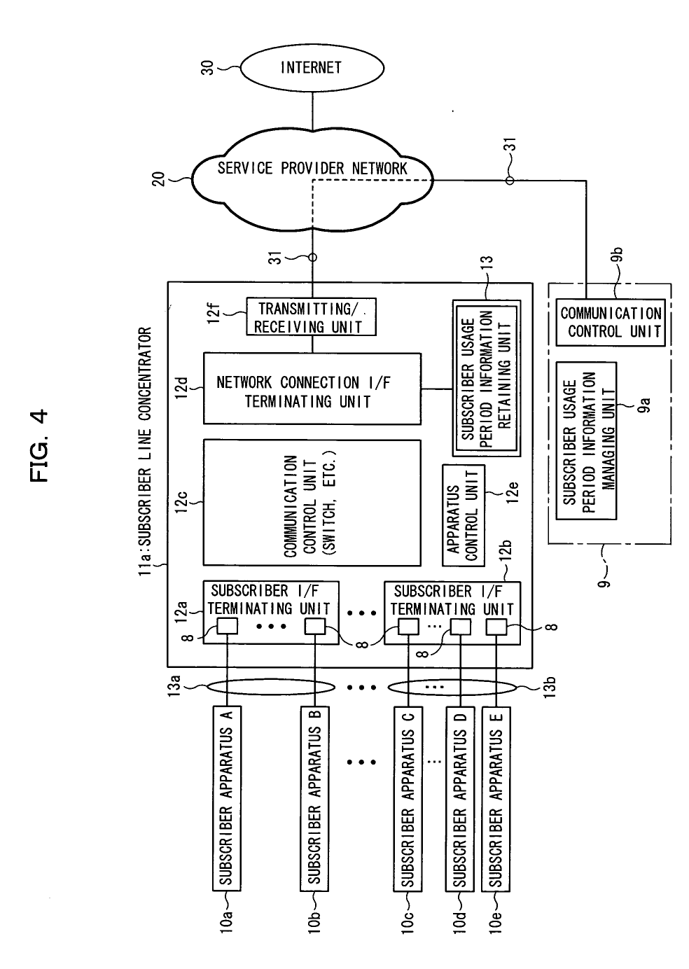

FIG. 4 is a block diagram of the subscriber line concentrator 11a according to the first embodiment of this invention. The subscriber line concentrator 11a shown in FIG. 4 comprises subscriber interface terminating units (subscriber I/F terminating units or subscriber I/Fs) 12a and 12b, a communication control unit 12c, a network connection interface terminating unit (network connection I/F terminating unit or network connection I/F) 12d, an apparatus control unit 12e, a transmitting/receiving unit (transmitting unit) 12f and a subscriber usage period information retaining unit (recording unit) 13.

(3-1) Subscriber Interface Terminating Units 12a and 12b

The subscriber interface terminating unit 12a has a function of processing the format of information data from the subscriber apparatus 10a or 10b and outputting the information data whose format has been processed to the communication control unit 12c, and a function of processing the format of information data from the network 20 and outputting the information data whose format has been processed to the subscriber line concentrator 11a or 11b. The subscriber interface terminating unit 12a has a plurality of ports (physical ports) 8 for outputting/inputting packets to/from the subscriber apparatuses 10a and 10b, respectively.

In other words, the subscriber interface terminating unit 12a converts the formats of information data from the subscriber apparatuses 10a and 10b and information data from the network 20.

The subscriber interface terminating unit 12b is identical to the subscriber interface terminating unit 12b, repetitive description of which is thus omitted.

(3-2) Communication Control Unit 12c

The communication control unit 12c multiplexes frames from the subscriber interface terminating units 12a and 12b and outputs them to the network connection interface terminating unit 12d, while demultiplexing a multiplexed frame received from the network connection interface terminating unit 12d. The communication control unit 12c extracts an MAC (Media Access Control) address of a frame from the subscriber interface terminating unit 12a or 12b, and outputs the frame to a port 8 corresponding to any one of the subscriber apparatuses 10a through 10e that is the destination of the frame. Accordingly, the communication control unit 12c has a layer 2 switch function.

In other words, the communication control unit 12c multiplexes and demultiplexes packets from the subscriber interface terminating units 12a and 12b and packets from the network connection interface terminating unit 12d, respectively.

(3-3) Network Connection Interface Terminating Unit 12d, Apparatus Control Unit 12e and Transmitting/Receiving Unit 12f

The network connection interface terminating unit 12d processes the formats of a packet from the communication control unit 12c and a packet from the network 20, and outputs them.

The apparatus control unit 12e controls each module provided in the subscriber line concentrators 11a and 11b.

The transmitting/receiving unit 12f can transmit the usage period information data recorded in the subscriber usage period information retaining unit 13 to the communication managing apparatus 9 which is possessed by the equipment vendor who sells the subscriber apparatuses 10a through 10e and the like to the communication carrier, and manages the usage period information. The transmitting/receiving unit 12f functions as a transmitting unit.

The transmitting/receiving unit 12f receives a request message for the usage period information data recorded in the subscriber usage period information retaining unit 13 from an external remote apparatus (for example, the communication managing apparatus 9) of the subscriber line concentrators 11a and 11b.

The transmitting/receiving unit 12f retains the usage period information data in a memory (not shown) to which the communication managing apparatus 9 can access when receiving a request message, for example. The communication managing apparatus 9 remotely reads out the usage period information data. Accordingly, the transmitting/receiving unit 12f also functions as a reading means that can remotely read out the retained information data in response to a request from the external equipment (the communication managing apparatus 9).

(4) Subscriber Usage Period Information Retaining Unit 13

The subscriber usage period information retaining unit 13 is a memory recording usage period information data relating to a connection history between each of the subscriber apparatuses 10a through 10e lent from the communication carrier providing the connection service and the network 20. The subscriber usage period information retaining unit 13 functions as a recording unit.

The subscriber usage period information retaining unit 13 records the usage period information data of each of the plural subscriber apparatuses 10a through 10e, and the transmitting/receiving unit 12f transmits the usage period information data of each of the subscriber apparatuses 10a through 10e to the communication managing apparatus 9.

The subscriber usage period information retaining unit 13 will be next described in more detail.

FIG. 5 is a diagram showing an example of retained data in the subscriber usage period information retaining unit 13 according to the first embodiment of this invention. The subscriber usage period information retaining unit 13 records usage period information data relating to a period of time from when communication between each of the subscriber apparatuses 10a through 10e and the network 20 becomes possible to when the communication between each of the subscriber apparatuses 10a through 10e and the network 20 is released. In practice, the subscriber usage period information retaining unit 13 relates “occurring date/time” representing the date and time when an event (registration or deletion) relating to identification information on the subscriber apparatuses 10a through 10e occurs, “occurring event” relating to registration or deletion of the identification information A, B, . . . or E on the subscriber apparatus 10a through 10e, and “occurring position” representing a position or place where the event occurs to one another, and retains them.

For example, it is recorded that the identification information on the subscriber apparatus 10a is registered at 10 a.m., on Oct. 1, 2002, and the position of the subscriber apparatus 10a, that is, the subscriber apparatus 10a is managed (being a follower of) by the line of the subscriber line concentrator 11a.

The communication control unit 12c shown in FIG. 4 multiplexes data transmitted from the subscriber apparatus 10a and data from the subscriber apparatus 10b toward the network 20, and fills the multiplexed data into a frame in a desirable format, and transmits the frame to the network 20 through the network connection interface terminating unit 12d.

The communication control unit 12c receives a packet or a frame from the network 20 through the network connection interface terminating unit 12d, demultiplexes data addressed to the subscriber apparatus 10a through 10e contained in the packet or frame, and transmits the demultiplexed data to the subscriber apparatus 10a through 10e.

(5) Structure of Communication Managing Apparatus 9

The communication managing apparatus 9 (refer to FIGS. 1 and 4) obtains data (FIG. 5) retained in the subscriber usage period information retaining unit 13 of each of the subscriber line concentrators 11a and 11b. The communication managing apparatus 9 comprises a subscriber usage period information managing unit (obtaining unit or managing unit: hereinafter referred as a managing unit) 9a and a communication control unit 12b.

The managing unit 9a obtains usage period information data relating to a connection history between each of the subscriber apparatuses 10a through 10e lent from the communication carrier providing the connection service and the network 20 from the subscriber line concentrators 11a and 11b. The managing unit 9a functions as an obtaining unit to manage the usage period information. The usage period information is service providing period information on each subscriber. The managing unit 9a keeps information in the subscriber line concentrators 11a and 11b almost intact.

A function of calculating the usage fee can be realized relatively easily with application software executing the operational process. Accordingly, the managing unit 9a may have, aside from the obtaining function, a calculating function of calculating the usage fee of the lent subscriber apparatuses and subscriber line concentrators on the basis of the usage period information obtained by means of the obtaining function.

Information data required to calculate the usage fee is determined on the basis of two elements, that is, service providing period information notified from the communication managing apparatus 9 and a contract between the equipment vendor and the communication carrier. In this case, a retaining unit for retaining the usage fee is provided in the communication managing apparatus 9.

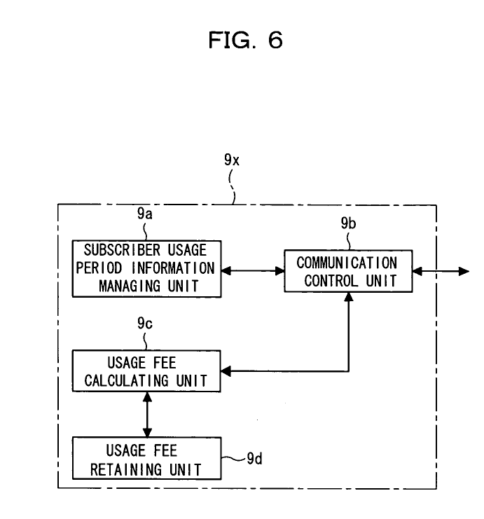

FIG. 6 is a block diagram of another communication managing apparatus 9 according to the first embodiment of this invention. A communication managing apparatus 9x shown in FIG. 6 comprises a usage fee calculating unit (calculating unit) 9c calculating the usage fee, and a usage fee retaining unit 9d retaining the usage fee calculated by the usage fee calculating unit 9c, aside from a subscriber usage period information managing unit 9a and a communication control unit 9b identical to those provided in the communication managing apparatus 9.

The usage fee calculating unit 9c calculates the usage fee on the basis of the usage period information retained in the managing unit 9a and the usage fee determined on the basis of a predetermined contract or the like between the equipment vendor and the communication carrier.

The communication managing apparatus 9x can retain not only the service providing period information on each subscriber but also the usage fee by calculating it.

The communication control unit 9b comprises a transmitting/receiving unit transmitting/receiving data to/from each of the subscriber line concentrators 11a and 11b in order to obtain retained data in the subscriber usage period information retaining unit 13, and a control unit controlling transmission/reception of the data.

Each of the communication managing apparatuses 9 and 9x receives a notification of the service providing period information from the subscriber line concentrators 11a and 11b lent from the equipment vendor to the communication carrier, or obtains the service providing period information on each of the subscriber apparatuses 10a through 10e. The equipment vendor who differs from the communication carrier providing the connection service remotely obtains the usage period information in the subscriber line concentrators 11a and 11b.

In other words, each of the communication managing apparatuses 9 and 9x functions as a remote management system. Further, each of the communication managing apparatuses 9 and 9x also functions as a fee calculation system.

(6) Modification of Communication Service System 100

As a communication path between the communication managing apparatus 9 and the subscriber line concentrators 11a and 11b shown in FIG. 1, the network 20 is used, and a part of the communication bandwidth used by the subscriber apparatuses 10a through 10e is used therefor. Namely, the communication managing apparatus 9 manages, as a fee calculating system, the usage period information using a part of the subscriber communication bandwidth so that the existing line can be efficiently used.

For the communication path, a dedicated line differing from the subscriber communication bandwidth may be used.

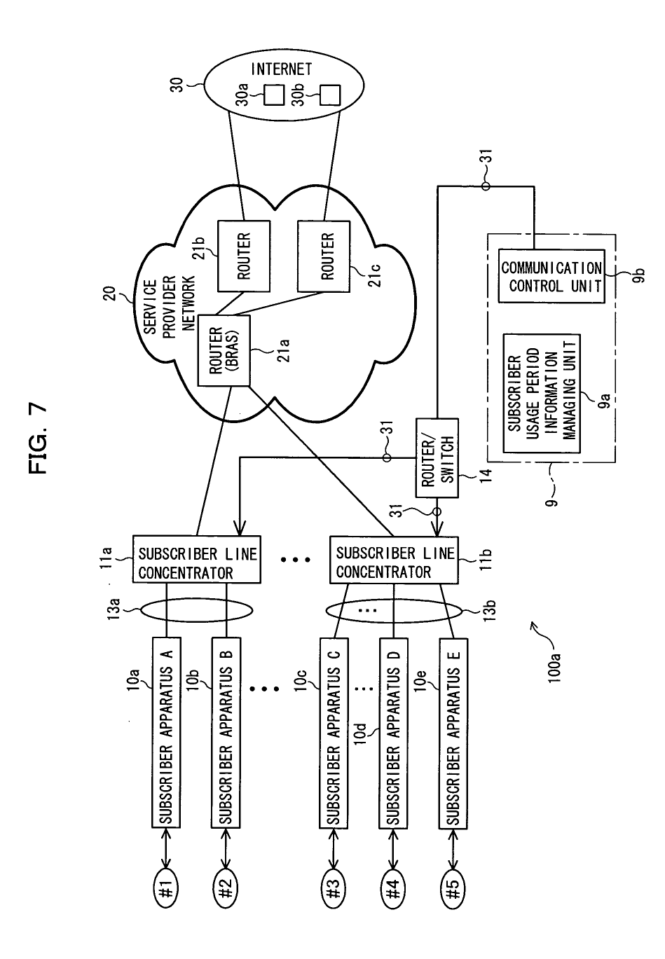

FIG. 7 is a diagram showing another structure of the communication service system according to the first embodiment of this invention. In a communication service system 100a shown in FIG. 7, a communication path between the communication managing apparatus 9 manages the usage period information for monitoring the usage period of the dedicated line. The communication managing apparatus 9 uses the dedicated line to monitor the usage period information, thereby managing the usage period information. Incidentally, like reference characters in FIG. 7 designate like or corresponding parts described above.

The router/switch 14 has a routing function for packets and a switching function for IP packets in layer 3, or a bridging function for MAC frames in layer 2 to fulfill either one of the routing function and the bridging function.

The bridging function refers to an MAC address of a frame, for example, to realize a transferring process in layer 2. A layer 2 processing unit (not shown) of the communication managing apparatus 9 bridges a frame from a LAN to the subscriber line concentrators 11a and 11b, for example, whereby information data can be transmitted and received. The dedicated line may be over a wide area LAN (Local Area Network), a WAN (Wide Area Network) or the like.

The routing function is a function of referring to an IP address of an IP packet, for example, to transfer the IP packet.

Meanwhile, a network having a protocol differing from that of the network 20 may be applied. For instance, a network giving a transfer label to a packet to transfer it, or a network which can virtually access to each communication apparatus in the network over physical transmission paths.

Each of the subscriber apparatuses 10a through 10e installed in the premise of the subscriber records (registers) the usage period with the subscriber line concentrator 11a or 11b, each of the subscriber line concentrators 11a and 11b can thereby grasp a state of the usable period of each of the subscriber apparatuses 10a through 10e.

In the connection service such as the FTTH service or the like, the communication carrier is confronted with a severe price-cutting race in order to acquire subscribers, and can hardly estimate the number of subscribers. For these reasons, the equipment investment to purchase the subscriber apparatuses 10a through 10e and the subscriber line concentrators 11a and 11b required to provide the service is suppressed, thus the equipment vendor fails to increase the sales of the equipments.

According to this invention, the communication carrier and the equipment vendor both can obtain information about the subscribers. Further, the equipment vendor can get a counter value according to a usage period of the subscriber apparatus from the communication carrier, thus can expect an increase in sales of the communication apparatuses.

(7) Communication Service Providing Method of the Invention

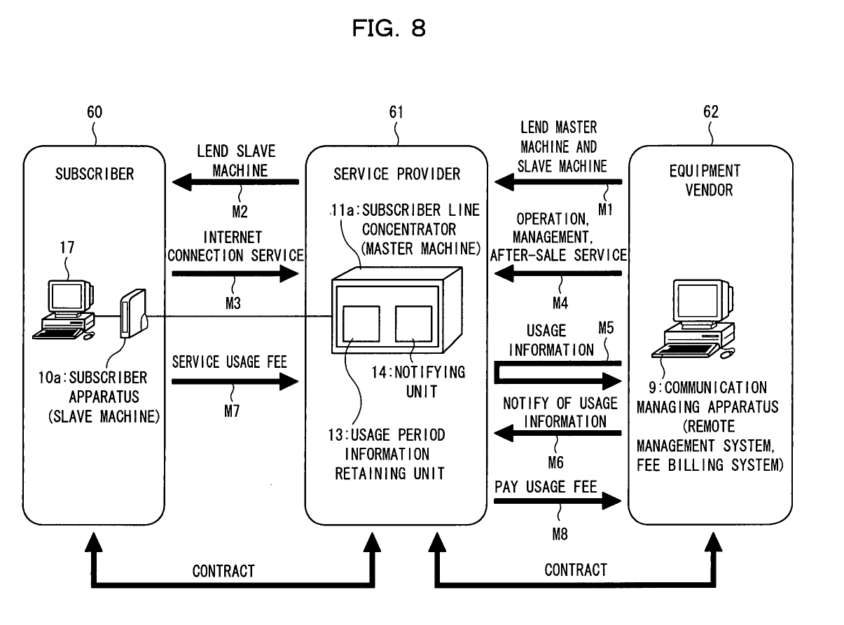

Next, description will be made of a communication service providing method with the above structure according to this invention with reference to FIG. 8. Here, M1 through M8 represent steps or operations.

FIG. 8 is a diagram showing a sequence for illustrating a communication service providing method according to the first embodiment of this invention. The equipment vendor 62 shown in FIG. 8 lends the subscriber line concentrator 11a and the subscriber apparatus 10a as a set of master and slave machines to the communication carrier (service providing enterprise) 61 (M1). The communication carrier 61 lends the subscriber apparatus 10a as a slave machine to the subscriber 60 (M2). The subscriber 60 operates a personal computer 17 of the subscriber 60 to connect the personal computer to the network 20, whereby the subscriber 60 and the network 20 are connected to each other (M3).

The subscriber apparatus 10a autonomously notifies the subscriber line concentrator 11a as the master machine of identification information A characteristic of the subscriber apparatus 10a when the power is switched on after the line is connected. When receiving the identification information A from the subscriber apparatus 10a, the subscriber line concentrator 11a records the identification information A as registration information on the subscriber apparatus 10a in a subscriber usage period information retaining unit 13 of the subscriber line concentrator 11a. Further, the subscriber line concentrator 11a retains an event that the subscriber line concentrator 11a received the identification information, the date/time when the event occurred, and information on the line over which the subscriber line concentrator 11a received the identification information A from the subscriber apparatus 10a in the subscriber usage period information retaining unit 13. In practice, the subscriber line concentrator 11a retains the occurring event together with the information on the line accommodating the subscriber apparatus 10a as log information in the subscriber usage period information retaining unit 13 of the subscriber line concentrator 11a.

The communication managing apparatus 9 of the equipment vendor 62 may always monitor whether the subscriber line concentrator 11a and the network 20 are normally operated (operation management) (M4). Further, the communication managing apparatus 9 may carry out the after-sale service in order to cope with a fault or the like of the communication equipment (M4).

When the service on the subscriber apparatus 10a is cancelled, the subscriber line concentrator 11a deletes the identification information A on the subscriber apparatus 10a retained in the subscriber usage period information retaining unit 13, whereby the connection service is stopped or terminated. The subscriber line concentrator 11a retains an event that the identification information was deleted, the date and time when the event occurred, and information on the line accommodating the subscriber apparatus 10a as log information inside the subscriber line concentrator 11a.

The retained log information is notified as usage period information from the subscriber line concentrator 11a to the communication managing apparatus 9 (M5).

(7-1) Service Usage Period

The service usage period of the subscriber apparatus 10a is from a start of the service to a stop of the service due to cancellation of the service. This definition corresponds to a period of time for which the subscriber line concentrator 11a providing the connection service provides the service to the subscriber apparatus 11a, that is, a period of time from a registration of the identification information A on the subscriber apparatus 11a with the subscriber line concentrator 11a to a deletion of the registration. The equipment vendor 62 uses the communication service system 100 (or 100a) to obtain log information or the like recorded in relation with registration and deletion of the identification information A on the subscriber apparatus 10a from the subscriber line concentrator 11a lent to the communication carrier (M5). Incidentally, the usage information includes both the subscribers (the number of subscribers) and the usage period information.

The equipment vendor 62 notifies the service providing enterprise 61 of the usage information and the usage fee on the basis of the received usage information (M6). Namely, the equipment vendor 62 also functions as a fee billing system.

The subscriber 60 pays the service usage fee to the service providing enterprise 61 (M7). The service providing enterprise 61 pays the usage fee to the equipment vendor 62 (M8). This usage information includes both the subscribers (the number of subscribers) and the usage period information.

The subscriber apparatuses 10b through 10e are similar to the subscriber apparatus 10a. The equipment vendor 62 can obtain the usage period information on each of the subscriber apparatuses 10a through 10e.

(7-2) Timing to Obtain Usage Period Information

In the communication service system 100, the usage period information on each of the subscriber apparatuses 10a through 10e retained in the communication managing apparatus 9 can be obtained through an apparatus management interface of the subscriber line concentrator 11a. The apparatus management interface obtains a log file when the communication managing apparatus 9 reads it out or the communication managing apparatus 9 is notified of it, and obtains the log file or displays information recorded in the log file.

As above, it is possible to read out the usage period information on each of the subscriber apparatuses 10a through 10e retained in the communication apparatus 9 from the communication managing apparatus 9 (external apparatus) designated by the equipment vendor.

When an event to be recorded in the log file occurs, the subscriber line concentrator 11a sends a notification packet to the communication service system 100 to notify an external apparatus designated by the equipment vendor of the usage period information on each of the subscriber apparatuses 10a through 10e.

The communication service providing method of this invention is a communication service providing method in the communication service system 100 providing the connection service between each of the subscriber apparatuses 10a through 10e and the network 20. The equipment vendor, who sells or lends communication apparatuses used for the communication service system 100 to the communication carrier providing the connection service, lends the subscriber apparatuses 10a through 10e which are possessed by the equipment vendor and to be lent from the communication carrier, and the subscriber line concentrators 11a and 11b which retain the connection histories between the subscriber apparatuses 10a through 10e and the network 20 (lending step).

The communication carrier records usage period information data relating to the connection histories in the subscriber line concentrators 11a and 11b lent at the lending step (recording step).

The equipment vendor calculates the usage fee of the subscriber apparatuses and the subscriber line concentrators lent from the equipment vendor on the basis of an obtaining step of obtaining the usage period information data recorded at the recording step and the usage period information data obtained at the obtaining step (calculating step).

At the calculating step, the usage fee may be fixedly determined on the basis of the number of the subscriber apparatuses 11a and 11b “2” and the number of the subscriber apparatuses 10a through 10e “5.” Alternatively, the usage fee may be selectively determined within a range from the number of the subscriber line concentrators 11a and 11b “2” to the number of subscriber apparatuses “5,” that is, the number of subscriber apparatuses 10a and 10b “2” concentrated by the subscriber line concentrator 11a plus the number of the subscriber apparatuses 10c through 10e “3” concentrated by the subscriber line concentrator 11b.

The equipment vendor notifies the communication carrier of the usage fee calculated at the calculating step (M6).

The communication carrier collects the usage fee calculated at the calculating step from the subscriber (first collecting step: M7). The equipment vendor collects the usage fee collected at the first collecting step from the communication carrier (second collecting step: M8).

The above manner is applied to between the subscriber apparatus 10b and the subscriber line concentrator 11a, and between each of the subscriber apparatuses 10c through 10e and the subscriber line concentrator 11b.

As above, the subscriber line concentrators 11a and 11b retain information about the time when the communication becomes possible with each of the subscriber apparatuses 10a through 10e and the time when the communication with each of the subscriber apparatuses 10a through 10e is cancelled, which correspond to a start and a stop of the service, on each of the subscriber apparatuses 10a through 10e. The retained information is remotely read out in response to a request from the outside. Accordingly, it is possible to readily read the information, not manually but automatically.

In the connection service such as the FTTH service or the like, the communication carrier pays the usage fee according to the usage period of the subscriber apparatus to the equipment vendor. For the communication carrier, the initial equipment investment is decreased so that the barrier to enter into the service is lowered. As a result, the communication carrier can commence the business more easily, and can expect an expansion of the business in the future, that is, can increase the equipments more easily.

As above, the equipment vendor can collect the usage fee according to a period for which the communication carrier provides the service to each of the subscriber apparatuses 10a through 10e from the communication carrier. The equipment vendor can expect an increase in profit due to expansion of the market, and an increase in sales of the equipments, because the barrier for the communication carrier to enter into the business is lowered.

### (B) Description of Second Embodiment of the Invention

In the first embodiment, there is described the method in which the equipment vendor lends the subscriber apparatuses 10a through 10e and the subscriber line concentrators 11a and 11b to the communication carrier.

In a service providing method according to a second embodiment, the equipment vendor possessing the subscriber apparatuses 10a through 10e and the subscriber line concentrators 11a and 11b for realizing the above line service sells the subscriber apparatuses 10a through 10e and the subscriber line concentrators 11a and 11b to a rental company lending the subscriber apparatuses 10a through 10e and the subscriber line concentrators 11a and 11b, and the rental company lends the subscriber apparatuses 10a through 10e and the subscriber line concentrators 11a and 11b to the communication carrier providing the line service to the subscribers. The equipment vendor collects the price of the subscriber apparatuses 10a through 10e and the subscriber line concentrators 11a and 11b from the rental company. The rental company collects the usage fee according to the period for which the communication carrier provides the service to the subscriber from the communication carrier.

In the second embodiment, the communication managing apparatus 9x is used like the communication managing apparatus 9. For this, only the communication managing apparatus 9 will be described unless specifically mentioned, repetitive description of which is thus omitted.

(8) Schematic Structure of Communication Service System 100 (or 100a)

As a communication service system according to the second embodiment, the communication service system 100 or 100a (refer to FIG. 1 or 7) according to the first embodiment is used, and the rental company can access to the communication managing apparatus 9. The transmitting/receiving unit 12f can transmit usage period information data recorded in the subscriber usage period information retaining unit 13 to the communication managing apparatus 9 possessed by the rental company lending the subscriber apparatuses 10a through 10e and the like to the communication carrier, and can manage the usage period information.

The communication system 100a is similar to the communication system 100, repetitive description of which is thus omitted.

(8-1) Rental Company

The equipment vendor sells the subscriber apparatuses 10a through 10e and the subscriber line concentrators 11a and 11b to the rental company, and obtains the counter value. The rental company lends the subscriber apparatuses 10a through 10e and the subscriber line concentrators 11a and 11b to the communication carrier, reads out the usage period information on each of the subscriber apparatuses 10a through 10e retained in the subscriber apparatuses 10a through 10e and the subscriber line concentrators 11a and 11b, notifies the communication carrier of the usage period information on each of the subscriber apparatuses 10a through 10e, and collects the usage fee from the communication carrier, or anything.

(8-2) Usage Period Information Notifying Method

The subscriber line concentrators 11a and 11b lent to the communication carrier from the rental company retain the usage period information on each of the subscriber apparatuses 10a through 10e for each of the subscriber apparatuses 10a through 10e, and autonomously notifies an external apparatus designated by the rental company of the retained information. The usage period information to be notified from the subscriber line concentrators 11a and 11b may be log information recording events having occurred in time series. The rental company may notify the communication carrier of the usage period information read out or notified from the subscriber line concentrators 11a and 11b intact.

The rental company may totalize, by means of a remote management system, the service usage periods of the subscriber apparatuses 10a through 10e by reading out them from the communication managing apparatus 9 as being an external apparatus designated by the rental company or on the basis of notified log information, and notify the communication carrier of the totalized usage period information.

(8-3) Calculation of Usage Fee (or Determination of Usage Fee)

When the number of subscriber apparatuses 10a through 10e connected to one subscriber line concentrator 11a or 11b is increased, the bandwidth of the network 20 usable by each of the subscriber apparatuses 10a through 10e is decreased. For this, the usage fee on the subscriber apparatuses 10a through 10e claimed by the communication carrier is set low.

The usage fee may be selectively determined within a range from the number of the subscriber line concentrators 11a and 11b “2” to a total “5” of the number of the subscriber apparatuses 10a and 10b “3” under the subscriber line concentrator 11a, and the number of the subscriber apparatuses 10c through 10e “3” under the subscriber line concentrator 11b, in consideration of the usable period information and the service fee collected from the subscribers by the communication carrier. Namely, the usage fee is set in consideration of the bandwidth practically usable and on the basis of a weight (or regressively) according to the number of the apparatuses. The number of the subscriber apparatuses 10a through 10e connected to each of the subscriber line concentrators 11a and 11b can be determined on the basis of the log information retained in the subscriber line concentrators 11a and 11b as described above.

The rental company may have a function of calculating a usage fee determined on the basis of a contract between the rental company and the communication carrier and billing the communication carrier the calculated usage fee with a remote management system.

This usage fee determining method may be employed in the first embodiment.

(9) Description of Operation

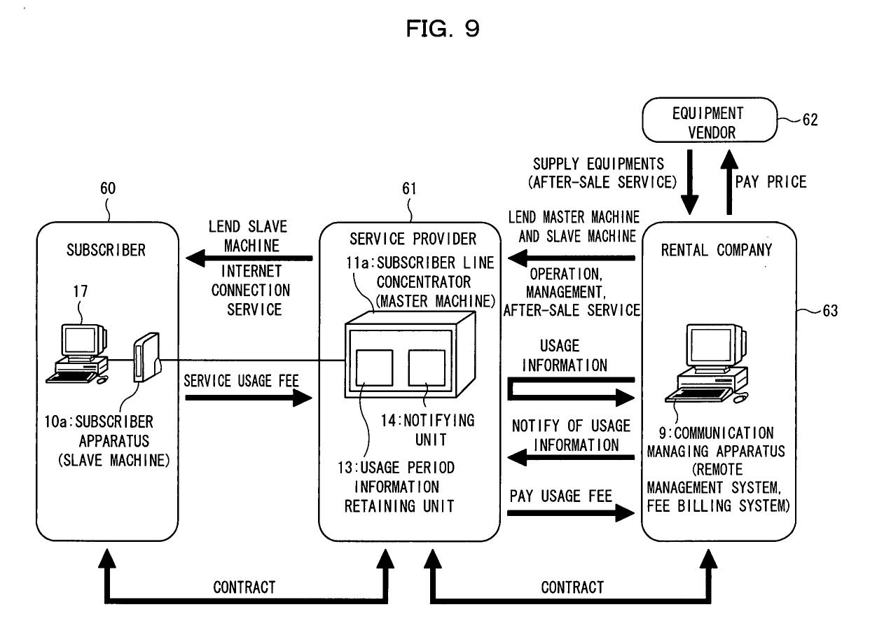

Next, description will be made of a communication service providing method with the above structure according to the second embodiment with reference to FIG. 9.

FIG. 9 is a diagram showing a sequence for illustrating the communication service providing method according to the second embodiment of this invention. The rental company 63 shown in FIG. 9 lends the subscriber apparatuses 10a and the subscriber line concentrator 11a to the communication carrier 61. When the subscriber line concentrator 11a recognizes that the subscriber apparatus 10a of the subscriber 60 is connected to the line 13a, the subscriber line concentrator 11a records the connection (connection event) as usage start period information on the subscriber apparatus 10a inside the apparatus.

The rental company 63 obtains the service providing period information on the subscriber apparatus 10a by a notification of the service providing period information from the subscriber line concentrator 11a, or over the dedicated line (refer to FIG. 7). The usage period information may be log information recording events having occurred in time series.

The rental company 63 totalizes the service usage periods of the subscriber apparatus 10a on the basis of log information by means of a remote management system, and notifies the communication carrier 61 of the totalized usage period information. The rental company 63 may notify the communication carrier 61 of the service usage periods on the basis of the usage period information read out or notified. Alternatively, the rental company 63 may notify the communication carrier 61 of the service usage periods intact.

The rental company 63 determines the usage fee on the basis of the number of the lent subscriber line concentrators 11a and 11b, and subscriber apparatuses 10a through 10e, and the usable period information on the subscriber apparatuses 10a through 10e. Alternatively, the rental company 63 may determine the usage fee on the basis of the maximum usable bandwidth, together with the above usable period information. Still alternatively, the rental company 63 may notify the communication carrier of the usage fee determined on the basis of a contract between the rental company 63 and the communication carrier 61.

The communication service providing method according to this invention is used in a communication service system 100 (100a) providing the connection service between the subscriber apparatuses 10a through 10e, and the network 20.

The equipment vendor 62, who sells or lends communication apparatuses used in the communication service system 100 (100a) to the communication carrier 61 providing the connection service, sells the subscriber apparatus 10a and the subscriber line concentrator 11a managing the connection history of the subscriber apparatus 10a with the network 20 to the rental company 63, who lends the communication apparatuses (selling step). The rental company 63 lends the subscriber line concentrator 11a to the communication carrier 61 (lending step).

The communication carrier 61 records the usage period information data relating to the connection history in the subscriber line concentrator 11a lent at the lending step.(recording step).

The rental company 63 obtains the usage period information data recorded at the recording step (obtaining step), and calculate each of the usage fee of the subscriber apparatuses 10a through 10e and the subscriber line concentrator 11a lent out (calculating step).

At the calculating step, the usage fee may be fixedly determined on the basis of the number of the plural subscriber line concentrators 11a and 11b, and the number of the plural subscriber apparatuses 10a through 10e. Alternatively, the usage fee may be selectively determined within a range from the number of the plural subscriber line concentrators 11a and 11b to the number of the subscriber apparatuses 10a through 10e concentrated by the subscriber line concentrators 11a and 11b. Further, the communication carrier 61 may collect the usage fee calculated at the calculating step from the subscriber 60 (first collecting step), and the rental company 63 may collect the usage fee collected at the first collecting step from the communication carrier 61 (second collecting step).

According to the second embodiment, the initial equipment investment is decreased, and the barrier to enter into the service is lowered, so that the communication carrier can commence the business more easily, and expand the business, that is, increase the equipments more easily.

As described above, a rental company differing from the communication carrier can determine the usage fee according to an actual service usage period recorded in the subscriber line concentrator 11a or 11b, and collect the usage fee from the communication carrier.

On the other hand, the equipment vendor can expect an increase in profit because of expansion of the market, resulted from that the barrier for the communication carrier to enter into the business is lowered.

### (C) Others

Note that the present invention is not limited to the above embodiments and modifications, but may be modified in various ways without departing from the scope of the invention.

When the network 20 uses FTTH, the subscriber apparatuses 10a through 10e and the subscriber line concentrators 11a and 11b may have an optical signal transmitting/receiving function, and an optical signal/electric signal modulating/demodulating function.

1. A communication service system providing a connection service between at least one subscriber apparatus and a network comprising:
a subscriber line concentrator provided between said subscriber apparatus among communication apparatuses used for said connection service and said network to record connection history information data relating to a connection history between said subscriber apparatus and said network, and concentrating said subscriber apparatus; and
a communication managing apparatus calculating a usage fee of said subscriber apparatus and said subscriber line concentrator lent out, on the basis of said connection history information data recorded in said subscriber line concentrator among said communication apparatuses used for said connection service.

2. A communication service providing method in a communication service system providing a connection service between at least one subscriber apparatus and a network, comprising the steps of:
a lending step of lending a communication carrier providing said connection service a subscriber line concentrator possessed by an equipment vendor selling or lending communication apparatuses used in said communication service system to said communication carrier, and retaining a connection history between said subscriber apparatus lent from said communication carrier and said network and concentrating said subscriber apparatus;
a recording step of recording, by said communication carrier, connection history information data relating to said connection history in said subscriber line concentrator lent out at said lending step;
an obtaining step of obtaining, by said equipment vendor, said connection history information data recorded at said recording step; and
a calculating step of calculating, by said equipment vendor, a usage fee of said subscriber apparatus and said subscriber line concentrator lent out, on the basis of said connection history information data obtained at said obtaining step.

3. A communication service providing method in a communication service system providing a connection service between at least one subscriber apparatus and a network, comprising the steps of:
a selling step of selling a subscriber line concentrator managing a connection history between said subscriber apparatus and said network and concentrating said subscriber apparatus from an equipment vendor selling or lending communication apparatuses used in said communication service system to a communication carrier providing said connection service to a company lending said communication apparatuses;
a lending step of lending said subscriber line concentrator from said company to said communication carrier;
a recording step of recording, by said communication carrier, connection history information data relating to said connection history in said subscriber line concentrator lent out at said lending step;
an obtaining step of obtaining, by said company, said connection history information data recorded at said recording step; and
a calculating step of calculating, by said company, a usage fee of said connection service on said subscriber apparatus and a usage fee of said subscriber apparatus and said subscriber line concentrator lent out, on the basis of said connection history information data obtained at said obtaining step.

4. A subscriber line concentrator provided between at least one subscriber apparatus and a network among communication apparatuses used in a communication service system providing a connection service between said subscriber apparatus and said network to concentrate said subscriber apparatus, said subscriber line concentrator comprising:
a recording unit recording connection history information data relating to a connection history between said subscriber apparatus lent from a communication carrier providing said connection service and said network; and
a transmitting unit transmitting said connection history information data recorded in said recording unit to a communication managing apparatus possessed by an equipment vendor selling or lending said communication apparatuses to said communication carrier and managing said connection history.

5. A communication managing apparatus being able to obtain data from a subscriber line concentrator concentrating at least one subscriber apparatus among communication apparatuses used in a communication service system providing a connection service between said subscriber apparatus and a network, said communication managing apparatus comprising:
an obtaining unit obtaining connection history information data relating to a connection history between said subscriber apparatus lent from a communication carrier providing said connection service and said network from said subscriber line concentrator; and
a calculating unit calculating a usage fee of said subscriber apparatus and said subscriber line concentrator lent out, on the basis of said connection history information data obtained by said obtaining unit.

6. The subscriber line concentrator according to claim 4 further comprising a receiving unit receiving said connection history information data of each of said subscriber apparatuses from said communication managing apparatus.

7. The subscriber line concentrator according to claim 4, wherein said recording unit records said connection history information data obtained from the time that communication between said subscriber apparatus and said network becomes possible to the time that the communication between said subscriber apparatus and said network is cancelled.

8. The communication service providing method according to claim 3, wherein, at said calculating step, said usage fee is fixedly determined on the basis of the number of said subscriber line concentrators and the number of said subscriber apparatuses.

9. The communication service providing method according to claim 3, wherein, at said calculating step, said usage fee is selectively determined within a range from the number of said subscriber line concentrators to the number of said subscriber apparatuses concentrated by each of said subscriber line concentrators.

10. The communication service providing method according to claim 2 further comprising the steps of:
a first collecting step of collecting, by said communication carrier, said usage fee calculated at said calculating step from a subscriber; and
a second collecting step of collecting, by said equipment vendor, said usage fee collected at said first collecting step from said communication carrier.
